(19) United States
(12) Patent Application Publication
(10) Pub. No.: US 2014/0185714 A1
(43) Pub. Date: Jul. 3, 2014

(54) RADIO COMMUNICATION APPARATUS, RADIO COMMUNICATION METHOD, AND RADIO COMMUNICATION SYSTEM

(71) Applicant: FUJITSU LIMITED, Kawasaki-shi (JP)

(72) Inventors: Takashi Seyama, Kawasaki (JP); Takashi Dateki, Yokohama (JP)

(73) Assignee: FUJITSU LIMITED, Kawasaki-shi (JP)

(21) Appl. No.: 14/107,912

(22) Filed: Dec. 16, 2013

(30) Foreign Application Priority Data
Dec. 27, 2012 (JP) 2012-286180

(51) Int. Cl. H04L 25/02

(52) U.S. Cl. CPC H04L 25/0202
USPC 375/340; 375/316

(57) ABSTRACT

A radio communication apparatus including: an antenna configured to receive a radio frame including first symbols to which reference signals are mapped and second symbols to which data is mapped, and a processor configured to determine a number of third symbols, the third symbols being used for demodulating each of the second symbols, and to select, for each of the second symbols, the third symbols from among the first symbols in accordance with the number.

### CROSS-REFERENCE TO RELATED APPLICATION

This application is based upon and claims the benefit of priority from the prior Japanese Patent Application No. 2012-286180 filed on Dec. 27, 2012, the entire contents of which are incorporated herein by reference.

### FIELD

The embodiments discussed herein are related to a technique of estimating a channel in a radio communication system.

### BACKGROUND

In a mobile station apparatus, a channel estimation technique is known to estimate a communication channel between the mobile station apparatus (or terminal) and a base station apparatus based on a result of receiving a known reference signal.

A timing advance (TA) control technique is known as a method of determining up-link transmission timing. The base station apparatus transmits, to the mobile station apparatus, a correction value of the TA that is an offset of the up-link transmission timing with respect to down-link transmission timing (namely, TA corresponds to propagation delay between the mobile station apparatus and a base station apparatus).

In a receiving apparatus, it is known to switch a channel estimation mode depending on estimation accuracy, a measured rate of change in channel pulse response, or a rate of change in timing advance equal to a signal propagation time (see, for example, Japanese National Publication of International Patent Application No. 2001-520492).

### SUMMARY

According to an aspect of the invention, a radio communication apparatus includes an antenna configured to receive a radio frame including first symbols to which reference signals are mapped and second symbols to which data is mapped, and a processor configured to determine a number of third symbols, the third symbols being used for demodulating each of the second symbols, and to select, for each of the second symbols, the third symbols from among the first symbols in accordance with the number.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a configuration of a communication system.

FIG. 2 is a diagram illustrating an example of a down-link transmission format.

FIG. 3 is a diagram illustrating a functional configuration of a base station apparatus.

FIG. 4 is a diagram illustrating a first example of a functional configuration of a mobile station apparatus.

FIG. 5 is a diagram illustrating an example of a channel estimation process.

FIGS. 6A to 6D are diagrams illustrating a first example of a method of selecting OFDM symbols used in channel estimation.

FIGS. 7A to 7D are diagrams illustrating a second example of a method of selecting OFDM symbols used in channel estimation.

FIG. 8 is a diagram illustrating a first example of a table used in setting the number of OFDM symbols used in channel estimation.

FIG. 9 is a diagram illustrating a first example of an operation of a mobile station apparatus.

FIG. 10 is a diagram illustrating a second example of a functional configuration of a mobile station apparatus.

FIG. 11 is a diagram illustrating a second example of a table used in setting the number of OFDM symbols used in channel estimation.

FIG. 12 is a diagram illustrating a third example of a table used in setting the number of OFDM symbols used in channel estimation.

FIG. 13 is a flow chart illustrating a second example of an operation of a mobile station apparatus.

FIG. 14 is a diagram illustrating an example of a hardware configuration of a base station apparatus.

FIG. 15 is a diagram illustrating an example of a hardware configuration of a mobile station apparatus.

### DESCRIPTION OF EMBODIMENTS

Use of a greater number of reference signals makes it possible to improve channel estimation accuracy. However, a time allowed for the mobile station apparatus to process a downlink channel signal is limited, and thus reference signals usable in the channel estimation are limited. Thus, there is a possibility that the restriction on the number of reference signals used in the channel estimation causes degradation in the reception performance.

The embodiments discussed herein provide an apparatus and a method that allow it to increase the number of reference signals used in the channel estimation thereby improving the reception performance.

### 1. Communication System

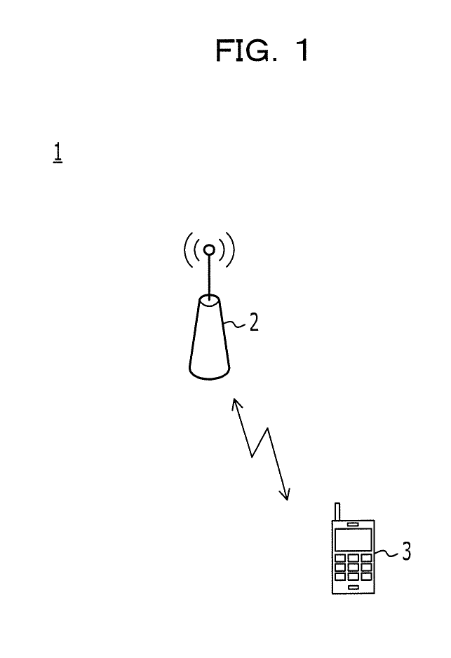

Embodiments are described below with reference to accompanying drawings. FIG. 1 is a diagram illustrating an example of a configuration of a communication system. The communication system 1 includes a base station apparatus 2 and a mobile station apparatus 3. Hereinafter, in the description and drawings, the base station apparatus and the mobile station apparatus will also be referred to as the base station and the mobile station.

The base station 2 is a wireless communication apparatus configured to wirelessly connect to the mobile station 3 to perform wireless communication. The base station 2 is capable of providing various kinds of services such as an audio communication, video distribution, and the like to the mobile station 3 in one or more cells. In the following description, it is assumed by way of example that the communication system 1 is based on a long term evolution (LTE) standard established by a standardization organization 3rd Generation Partnership Project (3GPP). Note that the communication system disclosed in the present description is not limited to that based on LTE, but the communication system disclosed herein may be applied to a wide variety of communication systems in which channel estimation is performed using a reference signal.

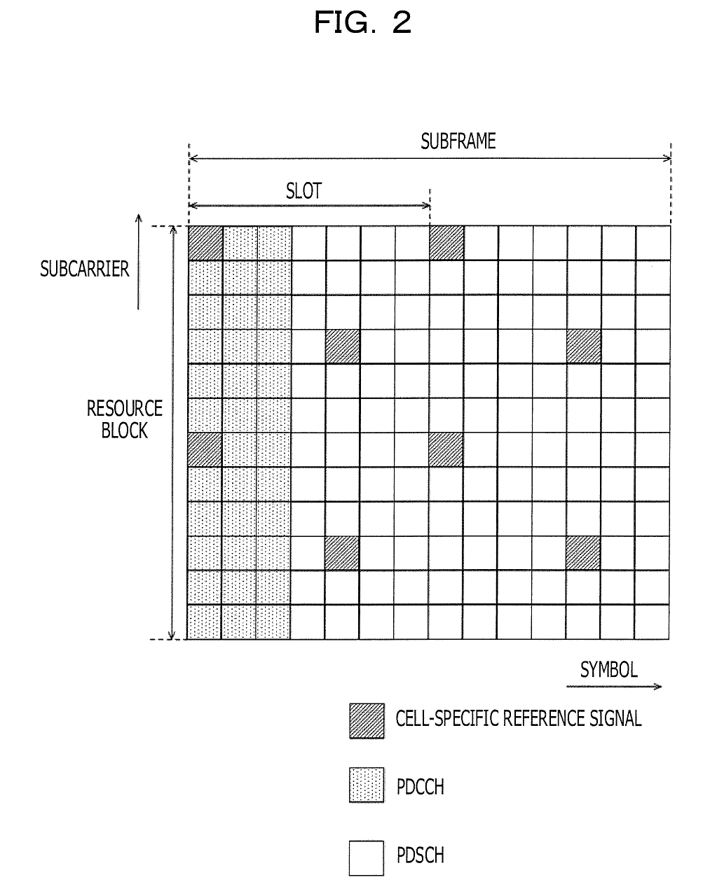

FIG. 2 is a diagram illustrating an example of a downlink transmission format. The transmission format is represented in a 2-dimensional space defined by a time axis and a frequency axis. In a direction along the time axis, elements are put in units of orthogonal frequency division multiplexing (OFDM) symbols, slots, and subframes. Each slot includes 7 OFDM symbols, and each subframe includes 2 slots.

In a direction along the frequency axis, elements are put in units of subcarriers and resource blocks (RBs). Each RB includes 12 subcarriers. In the example illustrated in FIG. 2, a cell-specific reference signal is mapped in a first OFDM symbol and a fifth OFDM symbol in the slot. In FIG. 2, symbols and carriers in which reference signals are put are denoted by areas hatched with diagonal lines. Hereinafter, in the following description and figures, the cell-specific reference signal will also be referred to as the “RS”.

A physical downlink control channel (PDCCH) in which a control channel is mapped is put at the beginning of a subframe. In the example illustrated in FIG. 2, PDCCHs are put in first three OFDM symbols shaded with dots. In the remaining radio resources, physical downlink shared channels (PDCCHs) are put in which data to be transmitted to the mobile station 3 is mapped.

### 2.1. Configuration According to First Embodiment

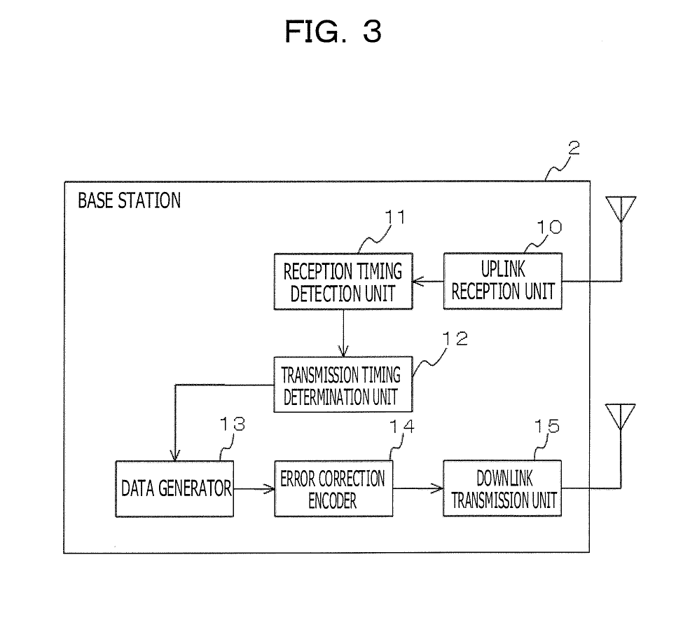

FIG. 3 illustrates a functional configuration of the base station 2. The base station 2 includes an uplink reception unit 10, a reception timing detection unit 11, a transmission timing determination unit 12, a data generator 13, an error correction encoder 14, and a downlink transmission unit 15.

The uplink reception unit 10 receives an uplink signal transmitted from the mobile station 3. The reception timing detection unit 11 detects reception timing of the uplink signal transmitted from the mobile station 3 and sends the detected reception timing to the transmission timing determination unit 12.

Based on the reception timing of the uplink signal transmitted from the mobile station 3, the transmission timing determination unit 12 determines whether the uplink transmission timing of the mobile station 3 is to be advanced or delayed, and generates a TA command to notify the mobile station 3 of a correction amount of TA. The transmission timing determination unit 12 inputs the TA command corresponding to the correction amount into the data generator 13.

The data generator 13 generates downlink data to be transmitted to the mobile station 3, and inputs the generated downlink data together with the TA command in a multiplexed form into the error correction encoder 14. The error correction encoder 14 converts the input data into error correction encoded data. The downlink transmission unit 15 generates a downlink signal by performing a modulation and the like on the input encoded data. The downlink transmission unit 15 transmits the downlink signal to the mobile station 3 via an antenna.

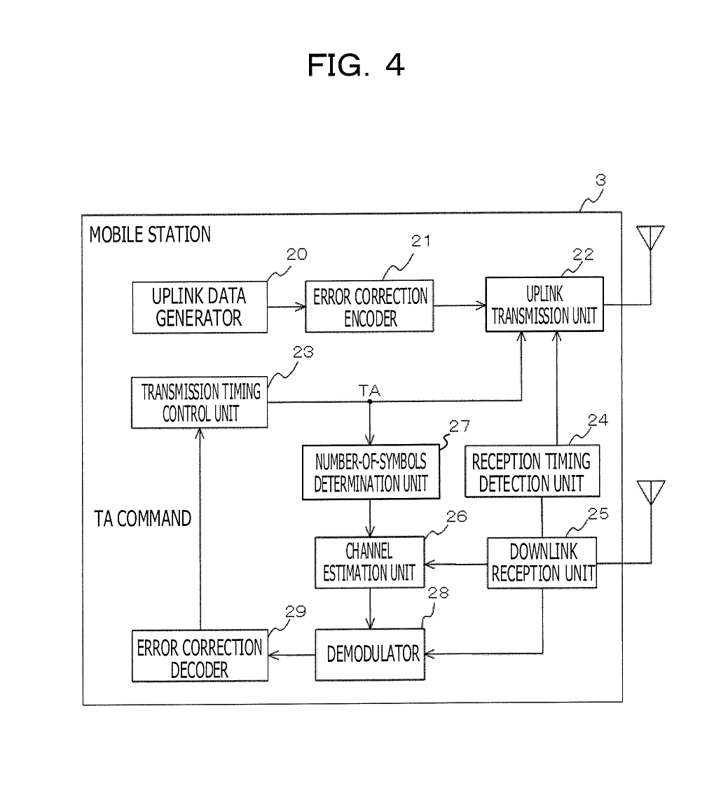

FIG. 4 illustrates a first example of a functional configuration of the mobile station 3. In this example, the mobile station 3 includes an uplink data generator 20, an error correction encoder 21, an uplink transmission unit 22, a transmission timing control unit 23, a reception timing detection unit 24, a downlink reception unit 25, and a channel estimation unit 26. The mobile station 3 further includes a number-of-symbols determination unit 27, a demodulator 28, and an error correction decoder 29.

The uplink data generator 20 generates uplink data to be transmitted to the base station 2 and inputs the generated uplink data into the error correction encoder 21. The error correction encoder 21 converts the input uplink data into error correction encoded data. The uplink transmission unit 22 performs a process including a modulation and the like on the encoded data thereby generating an uplink signal.

The uplink transmission unit 22 transmits the uplink signal to the base station 2 such that the timing of transmitting the uplink signal is ahead of the down-link transmission timing detected by the reception timing detection unit 24 by an amount equal to TA determined by the transmission timing control unit 23.

The downlink reception unit 25 receives the downlink signal transmitted from the base station 2. The reception timing detection unit 24 detects the reception timing of the downlink signal and outputs the detected reception timing to the uplink transmission unit 22.

The channel estimation unit 26 performs a channel estimation process based on the RS included in the downlink signal and the channel estimation unit 26 inputs a channel estimation value into the demodulator 28.

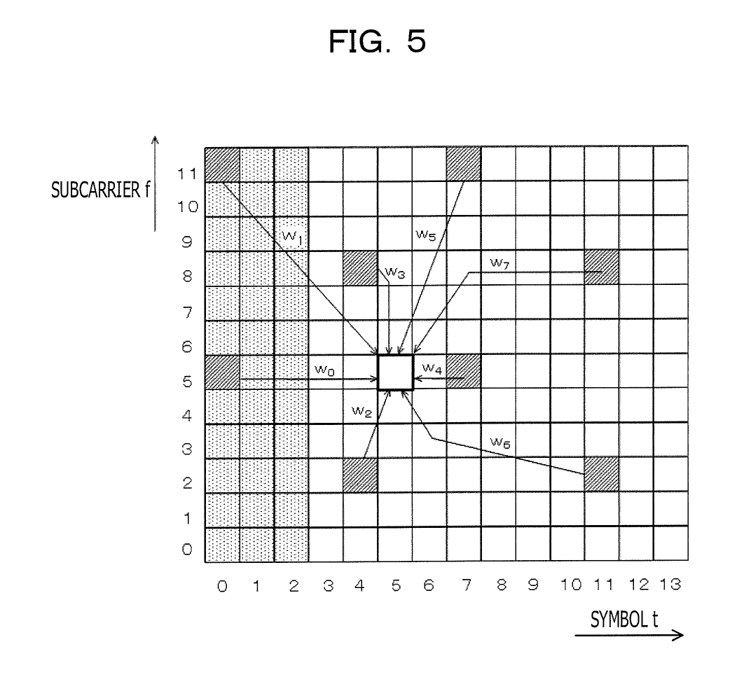

FIG. 5 is a diagram illustrating an example of the channel estimation process for a case in which the reference signals are distributed as illustrated in FIG. 2. The channel estimation unit 26 may calculate the channel estimation value, for example, by using a method called a two-dimensional minimum mean square error (MMSE) channel estimation method. In the 2-dimensional MMSE channel estimation, the channel estimation value is generated such that an RS pattern located close to a radio resource subjected to the channel estimation is multiplied by a complex conjugate of the original pattern thereby generating a zero-forcing (ZF) value, and the ZF value is weighted with a MMSE weight. More specifically, for example, the channel estimation value ĥ(t, f) for an OFDM symbol t and a subcarrier f may be given by a following equation.

$${h}^{\hat{}} ( t , f ) = [ \begin{matrix}{w}_{0} & {w}_{1} & {w}_{2} & {w}_{3} & {w}_{4} & {w}_{5} & {w}_{6} & {w}_{7}\end{matrix} ] [ \begin{matrix}{h}_{ZF} ( 0 , 5 ) \\ {h}_{ZF} ( 0 , 11 ) \\ {h}_{ZF} ( 4 , 2 ) \\ {h}_{ZF} ( 4 , 8 ) \\ {h}_{ZF} ( 7 , 5 ) \\ {h}_{ZF} ( 7 , 5 ) \\ {h}_{ZF} ( 7 , 11 ) \\ {h}_{ZF} ( 11 , 2 ) \\ {h}_{ZF} ( 11 , 8 )\end{matrix} ]$$

In the equation described above, h_{zf}(0, 5) and h_{zf}(0, 11) are respectively ZF values for 6th and 12th subcarriers in a first symbol. h_{zf}(4, 2) and h_{zf}(4, 8) are respectively ZF values for 3rd and 9th subcarriers in a 5th symbol. h_{zf}(7, 5) and h_{zf}(7, 11) are respectively ZF values for 6th and 12th subcarriers in an 8th symbol. h_{zf}(11, 2) and h_{zf}(11, 8) are respectively ZF values for 3rd and 9th subcarriers in a 12th symbol.

w0 and w1 are respectively weighting factors for the 6th and 12th subcarriers in the first symbol associated with the radio resource subjected to the channel estimation. w2 and w3 are respectively weighting factors for the 3rd and 9th subcarriers in the 5th symbol associated with the radio resource subjected to the channel estimation. w4 and w5 are respectively weighting factors for the 6th and 12th subcarriers in the 8th symbol associated with the radio resource subjected to the channel estimation. w6 and w7 are respectively weighting factors for the 3rd and 9th subcarriers in the 12th symbol associated with the radio resource subjected to the channel estimation.

Of OFDM symbols each including an RS, a particular number of OFDM symbols are selected and used by the channel estimation unit 26 in the channel estimation. Note that the particular number is specified by the number-of-symbols determination unit 27. According to the number of OFDM symbols specified by the number-of-symbols determination unit 27, the channel estimation unit 26 selects OFDM symbols to be used in the channel estimation from the OFDM symbols each including an RS.

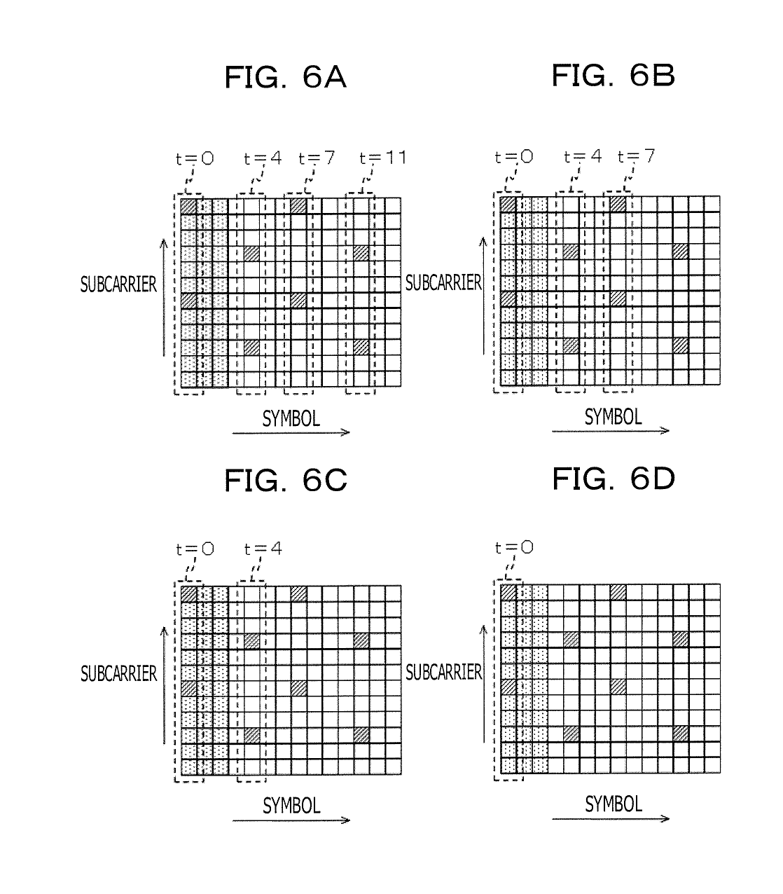

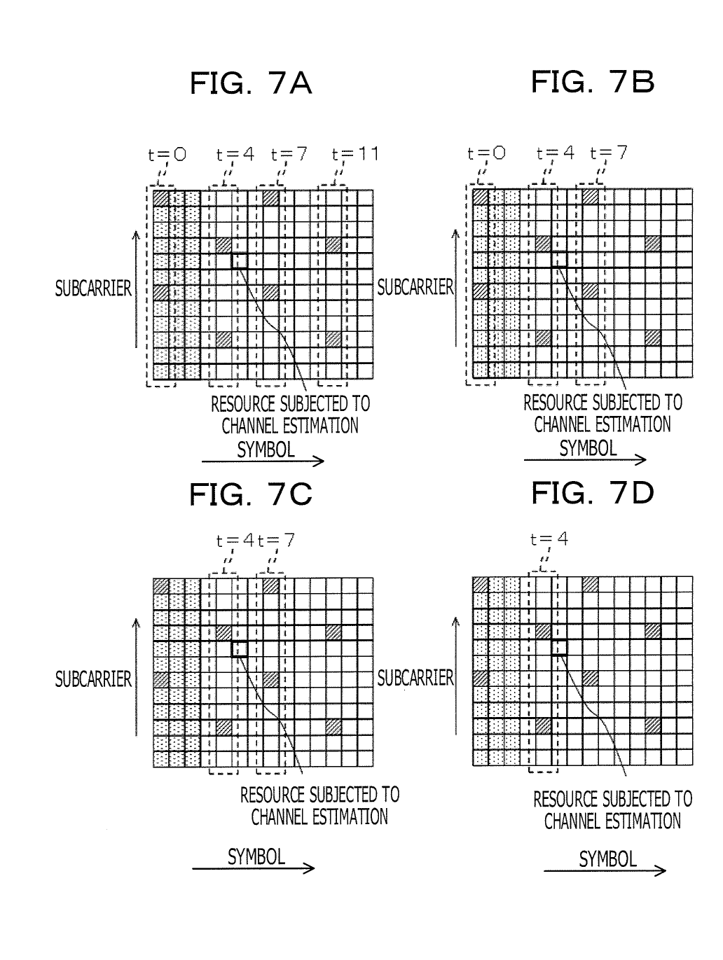

FIGS. 6A to 6D are diagrams illustrating a first example of a method of selecting OFDM symbols used in channel estimation. FIGS. 7A to 7D are diagrams illustrating a second example of a method of selecting OFDM symbols used in channel estimation. Herein it is assumed by way of example that an RS is included in each of the 1st, 5th, 8th, and 12th OFDM symbols.

FIGS. 6A to 6D illustrate examples of manners of selecting OFDM symbols for cases in which the numbers of OFDM symbols specified by the number-of-symbols determination unit 27 are respectively 4 to 1. The channel estimation unit 26 selects OFDM symbols in the order of locations from the closest to the top of the subframe to the farthest. That is, in the selection of OFDM symbols by the channel estimation unit 26, an OFDM symbol with earlier reception timing in the same subframe is given a higher priority.

In the example illustrated in FIG. 6A, the channel estimation unit 26 selects 1st, 5th, 8th, and 12th OFDM symbols. In the example illustrated in FIG. 6B, the channel estimation unit 26 selects the 1st, 5th, and 8th OFDM symbols.

In the example illustrated in FIG. 6C, the channel estimation unit 26 selects the 1st and 5th OFDM symbols. In the example illustrated in FIG. 6D, the channel estimation unit 26 selects the 1st OFDM symbol. In the channel estimation, use of OFDM symbols with earlier reception timing results in a reduction in RS waiting time, and thus it becomes possible to complete the channel estimation process in a shorter time.

FIGS. 7A to 7D illustrate examples of manners of selecting OFDM symbols for cases in which the numbers of OFDM symbols specified by the number-of-symbols determination unit 27 are respectively 4 to 1. The channel estimation unit 26 selects OFDM symbols such that higher priorities are given to OFDM symbols closer to the radio resource subjected to the channel estimation. The channel estimation accuracy is improved by selecting OFDM symbols closer to the radio resource subjected to the channel estimation.

Here, let it be assumed by way of example that the channel estimation is performed for a radio resource in which symbol t=5 and subcarrier f=7. In the example illustrated in FIG. 7A, the channel estimation unit 26 selects 1st, 5th, 8th, and 12th OFDM symbols. In the example illustrated in FIG. 7B, from the 1st, 5th, 8th, and 12th OFDM symbols, the channel estimation unit 26 selects three OFDM symbols closest to the resource of interest, and more specifically, the channel estimation unit 26 selects the 1st, 5th, and 8th OFDM symbols.

In the example illustrated in FIG. 7C, from the 1st, 5th, 8th, and 12th OFDM symbols, the channel estimation unit 26 selects two OFDM symbols closest to the resource of interest, and more specifically, the channel estimation unit 26 selects the 5th and 8th OFDM symbols. In the example illustrated in FIG. 7D, from the 1st, 5th, 8th, and 12th OFDM symbols, the channel estimation unit 26 selects one OFDM symbol closest to the resource of interest, and more specifically, the channel estimation unit 26 selects the 5th OFDM symbol. In a case where one OFDM symbol is selected from two OFDM symbols that are equally apart in time from the resource of interest, the channel estimation unit 26 may preferentially select an OFDM symbol with an earlier reception time.

Referring again to FIG. 4, the demodulator 28 demodulates the downlink signal using the channel estimation value calculated by the channel estimation unit 26, and the demodulator 28 inputs the demodulated downlink signal into the error correction decoder 29. The error correction decoder 29 reproduces data by performing an error correction decoding process. The error correction decoder 29 extracts a TA command notified from the base station 2 from the data and the error correction decoder 29 inputs the TA command into the transmission timing control unit 23.

The transmission timing control unit 23 updates the cumulative TA each time the transmission timing control unit 23 receives a TA command, and the transmission timing control unit 23 sends the TA to the uplink transmission unit 24 and the number-of-symbols determination unit 27. The number-of-symbols determination unit 27 determines, based on the notified TA, the number of OFDM symbols each including an RS used in the channel estimation.

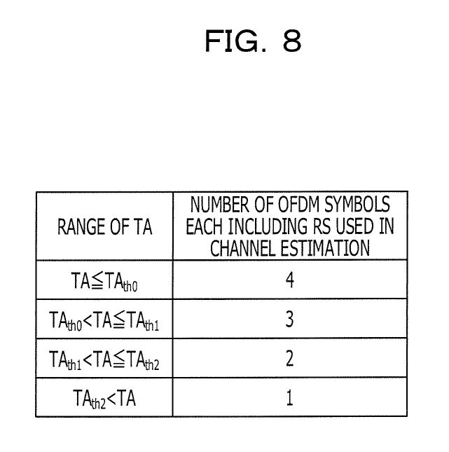

For example, the number-of-symbols determination unit 27 may compare the TA with one or more predetermined threshold values to set the number of OFDM symbols each including an RS used in the channel estimation. More specifically, for example, the number-of-symbols determination unit 27 may set the number of OFDM symbols, according to FIG. 8, depending on which one of ranges defined by three threshold values TAₜₕ₀, TAₜₕ₁, and TAₜₕ₂ (where TAₜₕ₀<TAₜₕ₁<TAₜₕ₂) the TA falls within.

The number-of-symbols determination unit 27 notifies the channel estimation unit 26 of the determined number of OFDM symbols. Note that in the determination of the number of OFDM symbols used in the channel estimation, the number-of-symbols determination unit 27 may use a calculation formula representing the number of OFDM symbols as a function of the TA.

### 2.2. Operation According First Embodiment

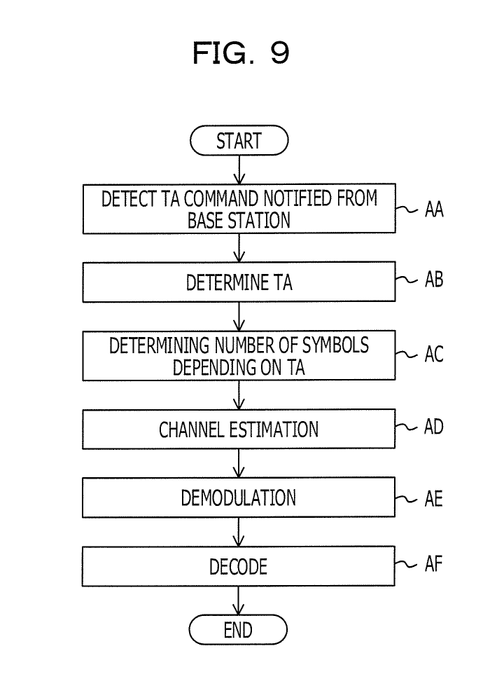

An operation of the mobile station 3 is described below. FIG. 9 is a diagram illustrating a first example of the operation of the mobile station 3. In an operation AA, the error correction decoder 29 detects a TA command included in the received data from the base station 2, and the error correction decoder 29 inputs the detected TA command into the transmission timing control unit 23. In an operation AB, the transmission timing control unit 23 updates the cumulative TA depending on the received TA command and the transmission timing control unit 23 sends the TA to the uplink transmission unit 24 and the number-of-symbols determination unit 27.

In an operation AC, the number-of-symbols determination unit 27 determines, based on the notified TA, the number of OFDM symbols each including an RS used in the channel estimation. In an operation AD, depending on the number of OFDM symbols specified by the number-of-symbols determination unit 27, the channel estimation unit 26 selects OFDM symbols to be used in the channel estimation. The channel estimation unit 26 calculates the channel estimation value using RSs of the selected OFDM symbols.

In an operation AE, the demodulator 28 demodulates the downlink signal using the channel estimation value calculated by the channel estimation unit 26, and the demodulator 28 inputs the demodulated downlink signal into the error correction decoder 29. In an operation AF, the error correction decoder 29 reproduces data by performing an error correction decoding process.

### 2.3. Advantageous Effects of Embodiment

According to the present embodiment, as described above, the mobile station 3 is capable of dynamically controlling the number of OFDM symbols used in the channel estimation depending on the TA defining the transmission timing. For example, in a case where the TA is short and a period until the transmission timing is relatively long, it is possible to use a larger number of OFDM symbols in the channel estimation thereby achieving an improvement in reception performance.

### 3.1. Second Embodiment

The number-of-symbols determination unit 27 may determine the number of OFDM symbols used in the channel estimation depending on a value of a signal other than a TA command in signals notified from the base station 2. That is, the number of OFDM symbols used in the channel estimation may be determined based on a value of one of signals notified from the base station 2.

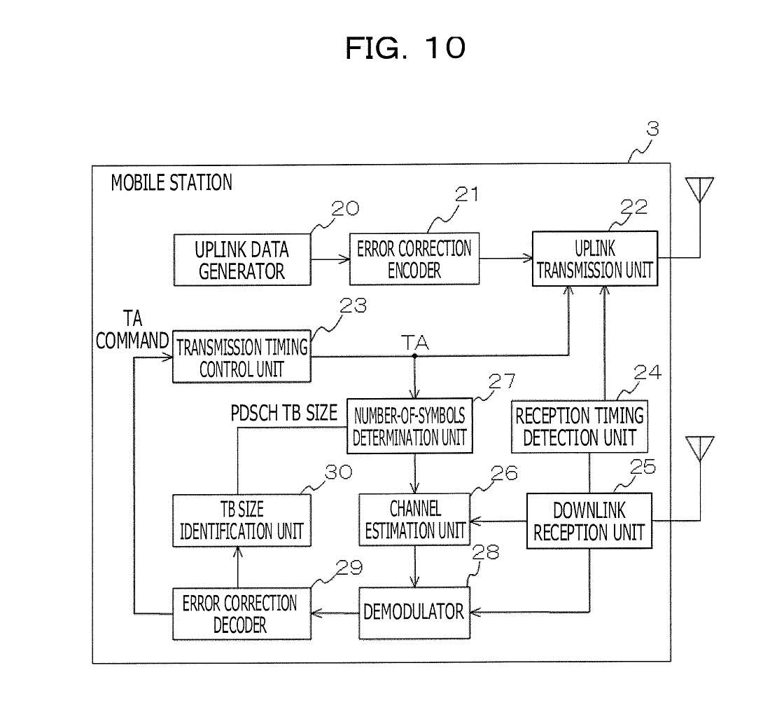

FIG. 10 is a diagram illustrating a second example of a functional configuration of the mobile station 3. Constituent elements similar to those in FIG. 5 are denoted by reference symbols similar to those in FIG. 5, and a further description of such constituent elements is omitted. The mobile station 3 includes a transport block size identification unit 30. Hereinafter, in the following description and figures, a transport block may also be referred to as a TB.

In the 3GPP LTE system, assignment of a PDSCH is notified using a PDCCH. The PDCCH includes information indicating the number of RBs assigned a PDSCH, a modulation and coding scheme (MCS) indicating a modulation method and a coding rate. The processing time for the demodulation process increases with the number of RBs assigned the PDSCH and with the order of modulation.

The size of the TB to be decoded becomes greater and the processing time for the error correction decoding process becomes longer with the increasing number of RBs assigned the PDSCH, with the increase order of modulation, and with the increasing coding rate. In view of the above, in a case where the TB size is relatively large, the mobile station 3 dynamically reduces the number of OFDM symbols used in the channel estimation thereby ensuring that the error correction decoding process has a sufficient processing time therefor. On the other hand, in a state where the TB size is relatively small, the number of OFDM symbols used in the channel estimation is dynamically increased.

The error correction decoder 29 decodes the PDCCH and notifies the TB size identification unit 30 of a result of decoding. The TB size identification unit 30 identifies the TB size of the PDSCH from the number of assigned RBs and the MCS included in the result of the decoding of the PDCCH, and the TB size identification unit 30 notifies the number-of-symbols determination unit 27 of the identified TB size. Based on the TB size, the number-of-symbols determination unit 27 determines the number of OFDM symbols each including an RS used in the channel estimation. Note that hereinafter, the TB size will also be referred to as the TBS.

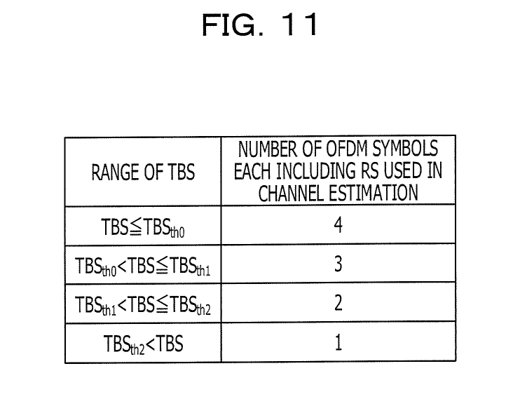

For example, the number-of-symbols determination unit 27 may compare the TBS with one or more predetermined threshold values to set the number of OFDM symbols each including an RS used in the channel estimation. More specifically, for example, the number-of-symbols determination unit 27 may set, according to FIG. 11, the number of OFDM symbols depending on which one of ranges defined by three threshold values TBSₜₕ₀, TBSₜₕ₁, and TBSₜₕ₂ (where TBSₜₕ₀<TBSₜₕ₁<TBSₜₕ₂) the TBS falls within.

The number-of-symbols determination unit 27 notifies the channel estimation unit 26 of the determined number of OFDM symbols. Note that in the determination of the number of OFDM symbols used in the channel estimation, the number-of-symbols determination unit 27 may use a calculation formula representing the number of OFDM symbols as a function of the TBS.

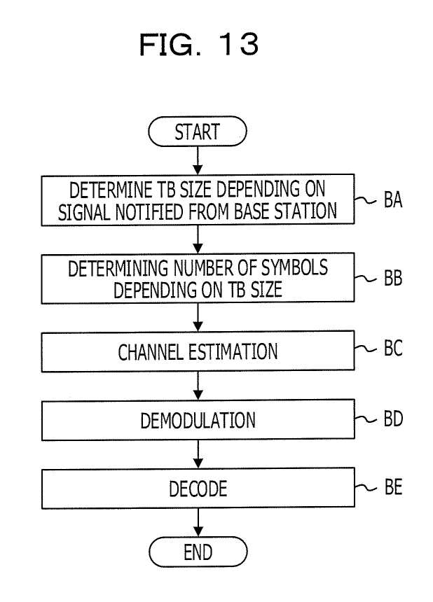

FIG. 13 is a diagram illustrating a second example of the operation of the mobile station 3. In an operation BA, the TB size identification unit 30 identifies the TB size of the PDSCH from the number of assigned RBs and the MCS included in the result of the decoding of the PDCCH. In an operation BB, the number-of-symbols determination unit 27 determines, based on the notified TB size, the number of OFDM symbols each including an RS used in the channel estimation. Operations BC to BE are respectively similar to operations AD to AF illustrated in FIG. 9.

According to the present embodiment, as described above, the mobile station 3 is capable of dynamically controlling the number of OFDM symbols used in the channel estimation depending on the TBS. More specifically, for example, when the TBS is large, the RS waiting time is reduced thereby ensuring that the error correction decoding process has a longer processing time therefor. On the other hand, for example, when the TBS is small, it is possible to use a larger number of OFDM symbols in the channel estimation thereby achieving an improvement in reception performance.

### 3.2. Examples of Modifications

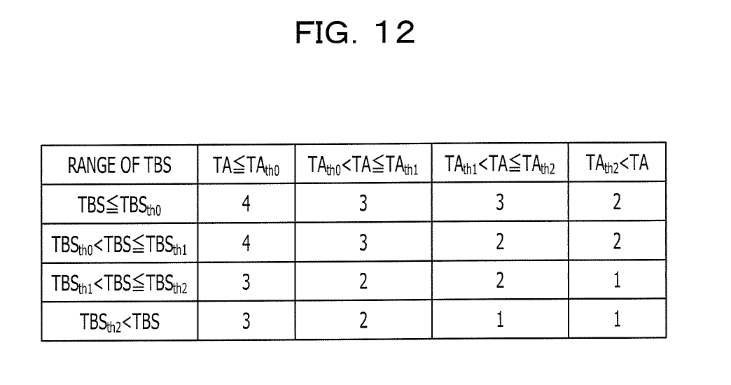

In the second embodiment, the number-of-symbols determination unit 27 may determine the number of OFDM symbols each including an RS used in the channel estimation based on both the TBS and the TA. More specifically, for example, the number-of-symbols determination unit 27 may determine the number of OFDM symbols according to FIG. 12 depending on which one of ranges defined by threshold values TAₜₕ₀, TAₜₕ₁, and TAₜₕ₂ the TA falls within, and which one of ranges defined by threshold values TBSₜₕ₀, TBSₜₕ₁, and TBSₜₕ₂ the TBS falls within.

For example, when the TA is within a range from TAₜₕ₀ to TAₜₕ₁ and the TBS is within a range from TBSₜₕ₁ to TBSₜₕ₂, the number of OFDM symbols used in the channel estimation is set to be equal to 2. On the other hand, for example, when the TA is smaller than TAₜₕ₀ and the TBS is in a range from TBSₜₕ₁ to TBSₜₕ₂, the number of OFDM symbols used in the channel estimation is set to be equal to 3. Note that in the determination of the number of OFDM symbols used in the channel estimation, the number-of-symbols determination unit 27 may use a calculation formula representing the number of OFDM symbols as a function of the TA and the TBS.

### 4. Hardware Configuration

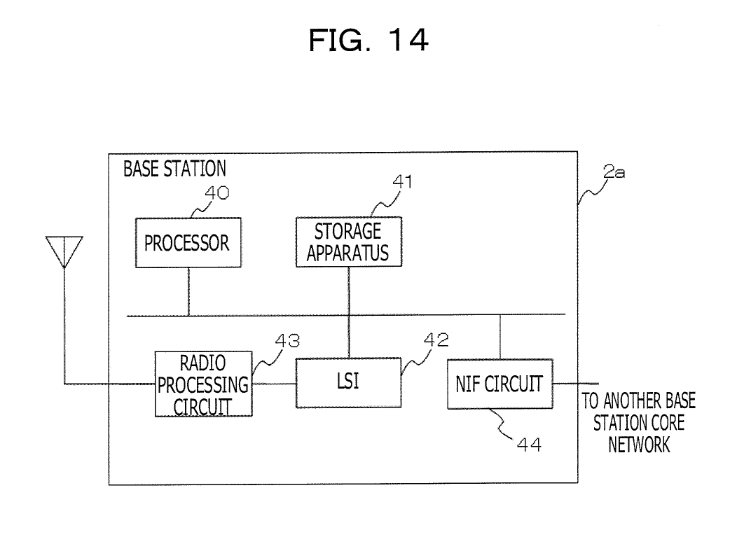

FIG. 14 is a diagram illustrating an example of a hardware configuration of the base station 2. The base station 2 includes a central processing unit (CPU) or the like serving as a processor 40, a storage apparatus 41, a large scale integration (LSI) 42, a radio processing circuit 43, and a network interface circuit 44. Hereinafter, in the following description and figures, the network interface will also be referred to as the NIF.

The storage apparatus 41 may include a nonvolatile memory, a read only memory (ROM), a random access memory (RAM), a hard disk drive apparatus, and/or the like, for storing a computer program and data. The processor 40 controls processes including a user management process other than processes performed by the LSI 42 described below and controls the operation of the base station 2 according to the computer program stored in the storage apparatus 41.

The LSI 42 performs processes including coding, modulating, demodulating, and decoding on a signal transmitted and received between the mobile station 3 and base station 2, a communication protocol process, and a process associated with scheduling on a baseband signal. The LSI 42 may include a field-programming gate array (FPGA), an application specific integrated circuit (ASIC), a digital signal processor (DSP), and/or the like.

The radio processing circuit 43 may include a digital-to-analog converter, an analog-to-digital converter, a frequency converter, an amplifier, a filter, and/or the like. The NIF circuit 44 includes an electronic circuit for communicating an upper-node apparatus via a wired network using a physical layer and a data link layer.

The above-described operations of the uplink reception unit 10, the reception timing detection unit 11, and the downlink transmission unit 15 of the base station 2 illustrated in FIG. 3 are performed by the radio processing circuit 43 and the LSI 42 in a cooperative manner. The above-described operations of the transmission timing determination unit 12 and the data generator 13 are performed by the processor 40. The above-described operation of the error correction encoder 14 is performed by the processor 40 and/or the LSI 42.

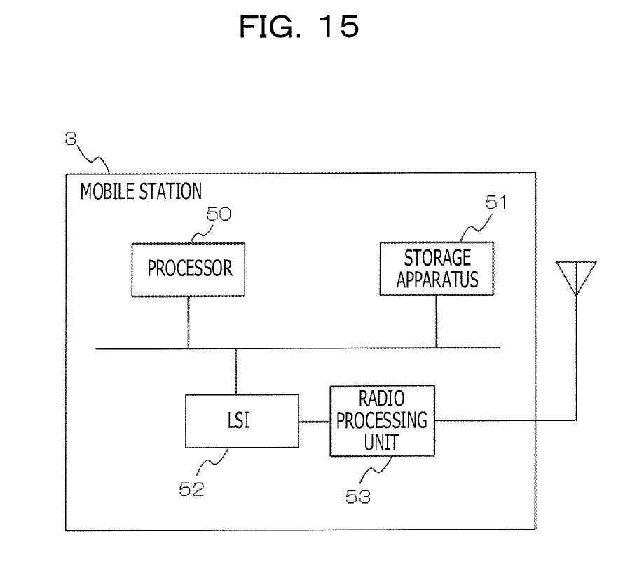

FIG. 15 is a diagram illustrating an example of a hardware configuration of the mobile station 3. The mobile station 3 includes a processor 50, a storage apparatus 51, an LSI 52, and a radio processing circuit 53. The storage apparatus 51 a nonvolatile memory, a ROM, a RAM, and/or the like, for storing a computer program and data.

According to the computer program stored in the storage apparatus 51, the processor 50 controls an operation of the mobile station 3 other than a process performed by the LSI 52 described below and also executes an application program to process user data.

The LSI 52 coding, modulating, demodulating, and decoding on a signal transmitted and received between the mobile station 3 and base station 2, a communication protocol process, and a process associated with scheduling on a baseband signal. The LSI 52 may include an FPGA, an ASIC, a DSP, and/or the like. The radio processing circuit 53 may include a digital-to-analog converter, an analog-to-digital converter, a frequency converter, and/or the like.

The above-described operations of the uplink transmission unit 22, the reception timing detection unit 24, and the downlink reception unit 25 of the mobile station 3 illustrated in FIG. 4 are performed by the radio processing circuit 53 and the LSI 52 in a cooperative manner. The above-described operations of the uplink data generator 20 the transmission timing control unit 23, the channel estimation unit 26, and the number-of-symbols determination unit 27 are performed by the processor 50. The operations of the error correction encoder 21, the demodulator 28, and the error correction decoder 29 are performed by the processor 50 and/or the LSI 52. The above-described operation of the TB size determination unit of the mobile station 3 illustrated in FIG. 10 is performed by the processor 50.

Note that the hardware configurations in FIGS. 14 and 15 are given only by way of example for illustration of the embodiments. In the present description, it is allowed to employ other configurations for the base station and the mobile station as long as the configurations are possible to perform the operations described above.

Note that the functional configurations illustrated in FIG. 3, FIG. 4, and FIG. 10 are mainly associated with the functions illustrated in the present description. However, the base station 2 and the mobile station 3 may include one or more constituent elements in addition to the constituent elements illustrated in the figures. The sequences of operations described above with reference to FIG. 9 and FIG. 13 may also be regarded as methods including a plurality of steps. In this case, “operations” may be read as “steps”.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A radio communication apparatus comprising:
an antenna configured to receive a radio frame including first symbols to which reference signals are mapped and second symbols to which data is mapped; and
a processor configured
to determine a number of third symbols, the third symbols being used for demodulating each of the second symbols, and
to select, for each of the second symbols, the third symbols from among the first symbols in accordance with the number.

2. The radio communication apparatus according to claim 1, wherein the processor prioritizes, when selecting the third symbols, a first symbol of the first symbols that is located closer to the top of the radio frame in time axis.

3. The radio communication apparatus according to claim 1, wherein the processor prioritizes, when selecting the third symbols for demodulating a second symbol of the second symbols, a first symbol of the first symbols that is located closer to the second symbol.

4. The radio communication apparatus according to claim 2, wherein the processor further prioritizes, when selecting the third symbols for demodulating a second symbol of the second symbols, a first symbol of the first symbols that is located closer to the second symbol.

5. The radio communication apparatus according to claim 1, wherein the processor determines the number in accordance with a length of a period for the demodulating.

6. The radio communication apparatus according to claim 1, wherein the processor determines the number in accordance with propagation delay between the radio communication apparatus and another apparatus which transmits the frame.

7. The radio communication apparatus according to claim 1, wherein the processor determines the number in accordance with a size of the data.

8. The radio communication apparatus according to claim 1, wherein the processor determines the number in accordance with propagation delay and a size of the data.

9. The radio communication apparatus according to claim 1, wherein for at least two symbols of the second symbols, the number for the one of the two symbols and the number for the other of the two symbols are different.

10. A radio communication method comprising:
receiving a radio frame including first symbols to which reference signals are mapped and second symbols to which data are mapped;
determining a number of third symbols, the third symbols being used for demodulating each of the second symbols; and
selecting, for each of the second symbols, the third symbols from among the first symbols in accordance with the number.

11. A radio communication system comprising:
a base station; and
a terminal, the terminal including
an antenna configured to receive a radio frame including first symbols to which reference signals are mapped and second symbols to which data is mapped, from the base station, and
a processor configured
to determine a number of third symbols, the third symbols being used for demodulating each of the second symbols, and
to select, for each of the second symbols, the third symbols from among the first symbols in accordance with the number.
